(19) United States
(12) Patent Application Publication
(10) Pub. No.: US 2016/0116711 A1
(43) Pub. Date: Apr. 28, 2016

(54) PHOTOGRAPHING LENS OPTICAL SYSTEM

(71) Applicant: KOLEN CO., LTD., Gyeonggi-do (KR)

(72) Inventors: Jong Jin Lee, Seoul (KR); Chan Goo Kang, Gyeonggi-do (KR)

(21) Appl. No.: 14/924,137

(22) Filed: Oct. 27, 2015

(30) Foreign Application Priority Data
Oct. 28, 2014 (KR) 10-2014-0147631

(51) Int. Cl. G02B 13/00; G02B 1/04; G02B 27/00; G02B 5/20; H04N 5/225; G02B 9/58

(52) U.S. Cl. CPC G02B 13/004; H04N 5/2254; G02B 9/58; G02B 27/0025; G02B 5/208; G02B 1/041

(57) ABSTRACT

Provided is a photographing lens optical system achieving high performance with low expenses. The lens optical system includes first to fourth lenses sequentially arranged along a light path between an object and an image sensor on which an image of the object is formed. The first lens has a negative refractive power and an incident surface convex toward the object, the second lens has a positive refractive power and an exit surface concave from the image sensor, the third lens has a positive refractive power and an exit surface convex toward the image sensor, and the fourth lens has a negative refractive power and an incident surface that is an aspherical surface having two or more inflection points.

### CROSS-REFERENCE TO RELATED APPLICATION

This application claims the benefit of Korean Patent Application No. 10-2014-0147631, filed on Oct. 28, 2014, in the Korean Intellectual Property Office, the disclosure of which is incorporated herein in its entirety by reference.

### BACKGROUND

1. Field

One or more exemplary embodiments relate to an optical device, and more particularly, to a lens optical system applied to a camera.

2. Description of the Related Art

Cameras having solid state imaging devices such as a charge-coupled device (CCD) and a complementary metal-oxide semiconductor (CMOS) image sensor applied thereto have been widely distributed.

Since a pixel integration degree of a solid state imaging device increases, resolution is being improved rapidly. In addition, the performance of a lens optical system has been greatly improved, and thus, cameras may have high performance, small sizes, and lightweight.

In a lens optical system of a general small camera, e.g., a camera for a mobile phone, an optical system including a plurality of lenses has one or more glass lenses. However, a glass lens has high unit manufacturing costs and makes it difficult to miniaturize the lens optical system due to limitations in forming/processing the glass lens.

In addition, a small lens optical system is a wide angle lens system that is difficult to close up within a predetermined distance. In particular, such small wide angle lens is not suitable for super-macro (contact) photography or macro (close-up) photography.

Therefore, a lens optical system capable of achieving high performance/high resolution while addressing the problems of a glass lens is required, wherein the optical lens system is a wide angle system for super-macro or macro photography.

### SUMMARY

One or more exemplary embodiments include a lens optical system that is manufactured with low manufacturing costs, is small in size, and lightweight.

One or more exemplary embodiments include a lens optical system of high performances, which is suitable for a high resolution camera.

One or more exemplary embodiments include a lens optical system that may be used in a super-macro or macro photography.

Additional aspects will be set forth in part in the description which follows and, in part, will be apparent from the description, or may be learned by practice of the presented embodiments.

According to one or more exemplary embodiments, a lens optical system includes: first to fourth lenses sequentially arranged along a light proceeding path between an object and an image sensor on which an image of the object is formed, wherein the first lens has a negative refractive power and an incident surface convex toward the object, the second lens has a positive refractive power and an exit surface concave from the image sensor, the third lens has a positive refractive power and an exit surface convex toward the image sensor, the fourth lens has a negative refractive power and an incident surface that is an aspherical surface having two or more inflection points, and the lens optical system satisfies at least one of the following conditions

90<FOV<120,

where FOV denotes a diagonal viewing angle of the lens optical system,

5<|DIST|<10,

where DIST denotes an optical distortion in a sensor effective region 1.0 field,

0.4<AL/TTL<0.9,

where AL denotes a distance from the aperture to the image sensor, and TTL denotes an optical distance from a center of an incident surface of the first lens to the image sensor,

20<Vd1−Vd2<40,

where Vd1 denotes an Abbe's number of the first lens and Vd2 denotes an Abbe's number of the second lens,

0.2<T12/F<0.8,

where T12 denotes an optical distance between a center of an exit surface of the first lens and a center of an incident surface of the second lens,

−10.0<F4/F<−1.0,

where F denotes a total effective focal distance of the lens optical system and F4 denotes a focal distance of the fourth lens,

1.0<F2/F<3.0,

where F denotes a total effective focal distance of the lens optical system and F2 denotes a focal distance of the second lens.

The first lens may be a meniscus lens.

At least one of the first to fourth lenses may be an aspheric lens.

One of an incident surface and an exit surface of at least one of the first to fourth lenses is an aspherical surface.

At least one of the first to fourth lenses comprises a plastic lens.

At least one of the first to fourth lenses may be an aberration correcting lens.

An aperture may be further disposed between the second lens and the third lens.

An infrared ray blocking unit may be further disposed between the object and the image sensor.

The infrared ray blocking unit may be disposed between the fourth lens and the image sensor.

According to one or more exemplary embodiments, a lens optical system includes a first lens, a second lens, a third lens, and a fourth lens sequentially arranged between an object and an image sensor on which an image of the object is formed from the object side, wherein the first to fourth lenses respectively have negative, positive, positive, and negative refractive powers, and the lens optical system satisfies at least one of the following Conditions 1 to 7,

90<FOV<120, <Condition 1>

where FOV denotes a diagonal viewing angle of the lens optical system,

5<|DIST|<10, <Condition 2>

where DIST denotes an optical distortion in a sensor effective region 1.0 field,

0.4<AL/TTL<0.9, <Condition 3>

where AL denotes a distance from an aperture to the image sensor, and TTL denotes an optical distance from a center of an incident surface of the first lens to the image sensor,

20<Vd1−Vd2<40, <Condition 4>

where Vd1 denotes an Abbe's number of the first lens and Vd2 denotes an Abbe's number of the second lens,

0.2<T12/F<0.8, <Condition 5>

where T12 denotes an optical distance between a center of an exit surface of the first lens and a center of an incident surface of the second lens,

−10.0<F4/F<−1.0, <Condition 6>

where F denotes a total effective focal distance of the lens optical system and F4 denotes a focal distance of the fourth lens,

1.0<F2/F<3.0, <Condition 7>

where F denotes a total effective focal distance of the lens optical system and F2 denotes a focal distance of the second lens.

The first lens may be a meniscus lens that is convex toward the object, the second lens is a meniscus lens that is concave from the image sensor, the third lens is convex toward the image sensor, and the fourth lens is convex toward the object.

The fourth lens may have an incident surface having two or more inflection points.

At least one of the first to fourth lenses is an aspheric lens.

### BRIEF DESCRIPTION OF THE DRAWINGS

These and/or other aspects will become apparent and more readily appreciated from the following description of the embodiments, taken in conjunction with the accompanying drawings in which:

FIGS. 1 to 4 are cross-sectional views illustrating arrangements of main elements of a lens optical system according to one or more exemplary embodiments;

FIG. 5 illustrates longitudinal spherical aberrations, astigmatic field curvatures, and distortion of a lens optical system, according to an exemplary embodiment;

FIG. 6 illustrates longitudinal spherical aberrations, astigmatic field curvatures, and distortion of a lens optical system, according to an exemplary embodiment;

FIG. 7 illustrates longitudinal spherical aberrations, astigmatic field curvatures, and distortion of a lens optical system, according to an exemplary embodiment; and

FIG. 8 illustrates longitudinal spherical aberrations, astigmatic field curvatures, and distortion of a lens optical system, according to an exemplary embodiment.

### DETAILED DESCRIPTION

Reference will now be made in detail to embodiments, examples of which are illustrated in the accompanying drawings, wherein like reference numerals refer to like elements throughout. Expressions such as “at least one of,” when preceding a list of elements, modify the entire list of elements and do not modify the individual elements of the list.

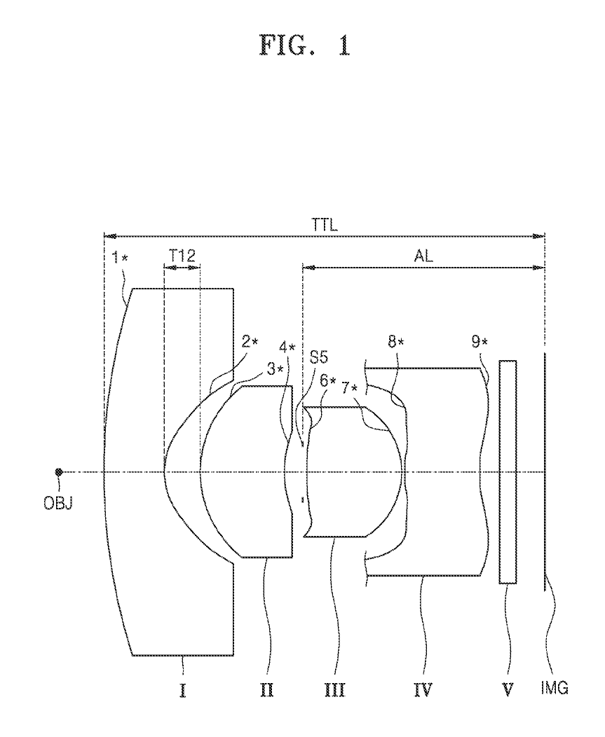

FIGS. 1 to 4 are cross-sectional views of a lens optical system according to one or more exemplary embodiments.

Referring to FIGS. 1 to 4, the lens optical system according to one or more exemplary embodiments includes a first lens I, a second lens II, a third lens III, and a fourth lens IV that are sequentially arranged between the object OBJ and an image sensor IMG on which an image of the object OBJ is formed, from an object OBJ side.

The first lens I may have a negative (−) refractive power, and may be convex toward the object OBJ. An incident surface 1* of the first lens I may be convex toward the object OBJ, and an exit surface 2* of the first lens I may be concave from an image sensor IMG. Therefore, the first lens I may be a meniscus lens having opposite surfaces, e.g., the incident surface 1* and the exit surface 2*, convex toward the object OBJ side.

The second lens II may have a positive (+) refractive power. An exit surface 4* of the second lens II may be concave from the object OBJ side, and an incident surface 3* of the second lens II may be convex toward the object OBJ side. Therefore, the second lens II may be a meniscus lens that is convex toward the object OBJ side.

The third lens III may have a positive (+) refractive power. In detail, the third lens III may be a bi-convex lens, an incident surface 6* and an exit surface 7* of which are convex toward the object OBJ side and the image sensor IMG side, respectively.

The fourth lens IV that is the last lens of the lens optical system may have a negative (−) refractive power, and may be convex toward the image sensor IMG. Here, an incident surface 8* of the fourth lens IV is convex toward the object OBJ side, and an exit surface 9* of the fourth lens IV may be convex toward the image sensor IMG side.

In the fourth lens IV, at least one of the incident surface 8* and the exit surface 9* may be an aspherical surface. For example, the incident surface 8* of the fourth lens IV may be an aspherical surface having at least two inflection points from a center portion to an edge thereof. In detail, the exit surface 9* of the fourth lens may be concave at the center thereof and convex toward the image sensor IMG side to the edge thereof.

At least one of the first to fourth lenses I to IV may be an aspheric lens. That is, at least one of the incident surface 1*, 3*, 6*, or 8* and the exit surface 2*, 4*, 7*, or 9* of at least one of the first to fourth lenses I to IV may be aspheric.

According to another exemplary embodiment, the incident surfaces 1*, 3*, 6*, and 8* and the exit surfaces 2*, 4*, 7*, and 9* of each of the first to fourth lenses I to IV may be both aspherical surfaces.

In addition, an aperture S5 and an infrared ray blocking unit V may be further disposed between the object OBJ and the image sensor IMG. The aperture S5 may be disposed between the second lens II and the third lens III. That is, the aperture S5 may be adjacent to the exit surface 4* of the second lens II.

The infrared ray blocking unit V may be disposed between the fourth lens IV and the image sensor IMG. The infrared ray blocking unit V may be an infrared ray blocking filter. The locations of the aperture S5 and the infrared ray blocking unit V may vary.

In FIGS. 1 to 4, a total track length (TTL) is a distance from a center of the incident surface 1* of the first lens I to the image sensor IMG, that is, a total length of the lens optical system.

In addition, AL denotes a distance from the aperture S5 to the image sensor IMG. T12 denotes a distance from a center of the exit surface 2* of the first lens I to a center of the incident surface 3* of the second lens II.

The lens optical system described above according to the exemplary embodiments may satisfy at least one of Conditions 1 to 7 below.

90<FOV<120 (1)

Here, FOV denotes a diagonal viewing angle of the optical system. As described above, the viewing angle is defined for configuring a macro or super-macro optical system, for example, an optical system for recognizing fingerprints or an optical system capable of performing a close-up photographing.

5<|DIST|<10 (2)

Here, DIST denotes an optical distortion of a valid region 1.0 field of the image sensor IMG.

The above condition defines a distortion aberration of the optical system so as to realize a wide angle with a reduced distortion when being compared with an optical system according to the prior art.

0.4<AL/TTL<0.9 (3)

Here, AL denotes a distance from the aperture S5 to the image sensor IMG, and TTL denotes an optical distance from the center of the incident surface 1* of the first lens I to the image sensor IMG. The above condition determines a location of the aperture S5 that adjusts an opening of the optical system. As such, an optimized wide angle optical system may be obtained.

20<Vd1−Vd2<40 (4)

Here, Vd1 denotes an Abbe's number of the first lens I, and Vd2 denotes an Abbe's number of the second lens II.

As described above, when the Abbe's number of the first lens I and the second lens II are defined so as to manufacture the first lens I and the second lens II with plastic, and accordingly, manufacturing costs may be reduced and aberration may be easily corrected.

0.2<T12/F<0.8 (5)

Here, T12 denotes an optical length between the center of the exit surface of the first lens I and the center of the incident surface of the second lens II. The above condition defines a distance between the first lens I and the second lens II. When the above Condition 5 is satisfied, aberration may be easily corrected and an optimized optical system may be obtained.

−10.0<F4/F<−1.0 (6)

Here, F denotes an entire effective focal length of the optical system, and F4 denotes a focal length of the fourth lens IV.

1.0<F2/F<3.0 (7)

Here, F denotes the entire effective focal length of the optical system, and F2 denotes a focal length of the second lens II.

The above Conditions 6 and 7 express arrangement of an optical power, and at the same time, defines a focal distance based on a ratio between the focal distance of the second lens II or the fourth lens IV and the focal distance of the optical system. As such, an optimized lens optical system may be obtained.

In the above exemplary embodiments (EMB1 to EMB4), Table 1 shows values of the above conditions EQU1 to EQU7.

TABLE 1

| # | EMB1 | EMB2 | EMB3 | EMB4 |
|---|---|---|---|---|
| FOV | 107.36 | 107.6 | 107.72 | 108.8 |
| EQU 1 | 107.36 | 107.6 | 107.72 | 108.8 |
| DIST(%) | −5 | −5 | −5 | −5 |
| EQU2 | −5 | −5 | −5 | −5 |
| AL | 5.99 | 6 | 5.99 | 5.87 |
| TTL | 10.9 | 11.2 | 11.19 | 11.1 |
| EQU3 | 0.55 | 0.54 | 0.54 | 0.53 |
| ABV1 | 55.86 | 55.86 | 55.86 | 55.86 |
| ABV2 | 22.43 | 22.43 | 22.43 | 22.43 |
| EQU4 | 33.42 | 33.42 | 33.42 | 33.42 |
| T12 | 0.89 | 1.03 | 1.03 | 1.07 |
| F | 2.16 | 2.15 | 2.14 | 2.11 |
| EQU5 | 0.41 | 0.48 | 0.48 | 0.51 |
| F4 | −10.19 | −10.25 | −10.16 | −9.08 |
| EQU6 | −5.05 | −4.77 | −4.74 | −4.31 |
| F2 | 5.4 | 5.92 | 5.9 | 5.79 |
| EQU7 | 2.5 | 2.75 | 2.75 | 2.75 |

As shown in Table 1, the exemplary embodiments EMB1 to EMB4 all satisfy the above conditions 1 to 7.

In the lens optical system having the above described structure according to the one or more exemplary embodiments, the first to fourth lenses I to IV may be formed of plastic by taking into account shapes and dimensions thereof. That is, all the first to fourth lenses I to IV may be plastic lenses. If a glass lens is used, a lens optical system not only has high manufacturing unit costs, but also is difficult to miniaturize due to limitations on forming/processing of the glass lens. However, since the first to fourth lenses I to IV may be formed of plastic, manufacturing unit costs may be decreased and a lens optical system may be miniaturized. If necessary, at least one of the first to fourth lenses I to IV may be formed of glass.

One or more exemplary embodiments #1 to #4 will be described in detail below with reference to lens data and accompanying drawings.

Table 2 to Table 5 below show a curvature radius, a lens thickness or a distance between lenses, a refractive index, and an Abbe's number of each lens included in the lens optical systems illustrated in FIGS. 1 to 4. In Table 2 to Table 5, S denotes a number of a lens surface, R denotes a curvature radius, D denotes a lens thickness, a lens interval, or an interval between adjacent elements, Nd denotes a refractive index of a lens measured by using a d-line, and Vd denotes an Abbe's number of a lens with respect to a d-line. A mark ‘*’ besides a lens surface number denotes that a lens surface is aspheric. Also, a unit of values of R and D is mm.

TABLE 2

| #1 | S | R | T | Nd | Vd |
|---|---|---|---|---|---|
| I | 1* | 21.4545 | 1.5000 | 1.5384 | 55.8559 |
| | 2* | 1.4577 | 0.8881 | | |
| II | 3* | 2.3820 | 2.1000 | 1.6622 | 22.4336 |
| | 4* | 4.6217 | 0.4280 | | |
| | S5 | Infinity | 0.1000 | | |
| III | 6* | 4.6859 | 2.3424 | 1.5384 | 55.8559 |
| | 7* | −1.4738 | 0.1000 | | |
| IV | 8* | 8.4402 | 1.8442 | 1.5384 | 55.8559 |
| | 9* | 3.1991 | 0.5000 | | |

TABLE 3

| #2 | S | R | T | Nd | Vd |
|---|---|---|---|---|---|
| I | 2* | 18.5143 | 1.5000 | 1.5384 | 55.8559 |
| | 3* | 1.4537 | 1.0301 | | |
| II | 4* | 2.6232 | 2.1000 | 1.6622 | 22.4336 |
| | 5* | 5.4064 | 0.5673 | | |
| | S5 | Infinity | 0.1000 | | |
| III | 7* | 3.3702 | 2.4796 | 1.5384 | 55.8559 |
| | 8* | −1.6557 | 0.1000 | | |
| IV | 9* | 8.4201 | 1.7193 | 1.5384 | 55.8559 |
| | 10* | 3.0957 | 0.5000 | | |

TABLE 4

| #3 | S | R | T | Nd | Vd |
|---|---|---|---|---|---|
| I | 1* | 18.0028 | 1.5000 | 1.5384 | 55.8559 |
| | 2* | 1.4482 | 1.0288 | | |
| II | 3* | 2.6436 | 2.1000 | 1.6622 | 22.4336 |
| | 4* | 5.5791 | 0.5740 | | |
| | S5 | Infinity | 0.1000 | | |
| III | 6* | 3.3623 | 2.4816 | 1.5384 | 55.8559 |
| | 7* | −1.6568 | 0.1000 | | |
| IV | 8* | 8.4931 | 1.7089 | 1.5384 | 55.8559 |
| | 9* | 3.0925 | 0.5000 | | |

TABLE 5

| #4 | S | R | T | Nd | Vd |
|---|---|---|---|---|---|
| I | 1* | 17.6366 | 1.5000 | 1.5384 | 55.8559 |
| | 2* | 1.4378 | 1.0694 | | |
| II | 3* | 2.6376 | 2.1000 | 1.6622 | 22.4336 |
| | 4* | 5.7767 | 0.5581 | | |
| | S5 | Infinity | 0.1000 | | |
| III | 6* | 3.3266 | 2.4976 | 1.5384 | 55.8559 |
| | 7* | −1.6142 | 0.1000 | | |
| IV | 8* | 7.9283 | 1.5765 | 1.5384 | 55.8559 |
| | 9* | 2.8133 | 0.5000 | | |

In addition, the aspherical surface of the each lens in the lens optical system according to the above exemplary embodiments satisfies the aspheric formula 8.

$$x = \frac{{c}^{′} {y}^{2}}{1 + \sqrt{1 - ( K + 1 ) {c}^{′ 2} {y}^{2}}} + {Ay}^{4} + {By}^{6} + {Cy}^{8} + {Dy}^{10} + {Ey}^{12} \qquad ( 8 )$$

Here, x denotes a distance from an apex of a lens in an optical axis direction, y denotes a distance in a direction perpendicular to an optical axis, c′ denotes a reciprocal number of a curvature radius at an apex of a lens (=1/r), K denotes a conic constant, and A, B, C, D, and E each denote an aspheric coefficient.

Tables 6 to 9 below show aspheric coefficients of aspherical surfaces respectively in the lens optical systems according to the exemplary embodiments illustrated in FIGS. 1 to 4. In other words, Tables 6 to 9 show aspheric coefficients of the incident surfaces 1*, 3*, 6*, and 8* and the exit surfaces 2*, 4*, 7*, 9*, and 11 * of Tables 2 to 5.

TABLE 6

| S | K | A | B | C | D |
|---|---|---|---|---|---|
| 1 | 18.4610 | 0.0009 | −0.0000 | — | — |
| 2 | −0.6436 | −0.0124 | −0.0019 | 0.0006 | −0.0002 |
| 3 | −0.3136 | −0.0063 | 0.0011 | 0.0001 | −0.0000 |
| 4 | 0.0000 | 0.0359 | 0.0008 | 0.0210 | −0.0094 |
| 6 | 0.0000 | −0.0017 | −0.0182 | 0.0276 | −0.0149 |
| 7 | −0.7744 | −0.0014 | 0.0045 | −0.0009 | −0.0001 |
| 8 | −190.8789 | −0.0085 | −0.0025 | 0.0002 | −0.0001 |
| 9 | −10.1441 | −0.0189 | 0.0023 | −0.0002 | −0.0000 |

Lens optical system according to the exemplary embodiment EMB1: F No.=2.45/f=2.1589 mm

TABLE 7

| S | K | A | B | C | D |
|---|---|---|---|---|---|
| 1 | 12.2976 | 0.0005 | −0.0000 | — | — |
| 2 | −0.6602 | −0.0082 | −0.0028 | 0.0008 | −0.0002 |
| 3 | −0.4560 | −0.0017 | 0.0014 | 0.0001 | −0.0000 |
| 4 | 0.0000 | 0.0386 | −0.0064 | 0.0207 | −0.0066 |
| 6 | 0.0000 | 0.0111 | −0.0049 | 0.0146 | −0.0090 |
| 7 | −0.9257 | 0.0032 | 0.0122 | −0.0041 | 0.0013 |
| 8 | −176.6806 | −0.0073 | −0.0014 | 0.0009 | −0.0004 |
| 9 | −9.4995 | −0.0210 | 0.0039 | −0.0005 | −0.0000 |

Lens optical system according to the exemplary embodiment EMB2: F No.=2.45, focal distance f=2.1477 mm

TABLE 8

| S | K | A | B | C | D |
|---|---|---|---|---|---|
| 1 | 11.3969 | 0.0003 | −0.0000 | — | — |
| 2 | −0.6667 | −0.0083 | −0.0033 | 0.0009 | −0.0002 |
| 3 | −0.4658 | −0.0014 | 0.0012 | 0.0002 | −0.0000 |
| 4 | 0.0000 | 0.0388 | −0.0043 | 0.0192 | −0.0062 |
| 6 | 0.0000 | 0.0122 | −0.0030 | 0.0117 | −0.0077 |
| 7 | −0.9358 | 0.0035 | 0.0130 | −0.0043 | 0.0014 |
| 8 | −192.7966 | −0.0070 | −0.0012 | 0.0009 | −0.0004 |
| 9 | −10.4799 | −0.0197 | 0.0038 | −0.0005 | −0.0000 |

Lens optical system according to the exemplary embodiment EMB3: F No.=2.45/f=2.1443 mm

TABLE 9

| S | K | A | B | C | D |
|---|---|---|---|---|---|
| 1 | 10.5498 | −0.0000 | −0.0000 | — | — |
| 2 | −0.6760 | −0.0086 | −0.0039 | 0.0009 | −0.0002 |
| 3 | −0.4887 | −0.0011 | 0.0010 | 0.0002 | −0.0000 |
| 4 | 0.0000 | 0.0396 | −0.0030 | 0.0201 | −0.0076 |
| 6 | 0.0000 | 0.0130 | 0.0004 | 0.0069 | −0.0059 |
| 7 | −0.9856 | 0.0050 | 0.0138 | −0.0046 | 0.0015 |
| 8 | −175.9404 | −0.0083 | −0.0006 | 0.0009 | −0.0004 |
| 9 | −10.7658 | −0.0202 | 0.0039 | −0.0005 | −0.0000 |

Lens optical system according to the exemplary embodiment EMB4: F No.=2.45/f=2.1061 mm

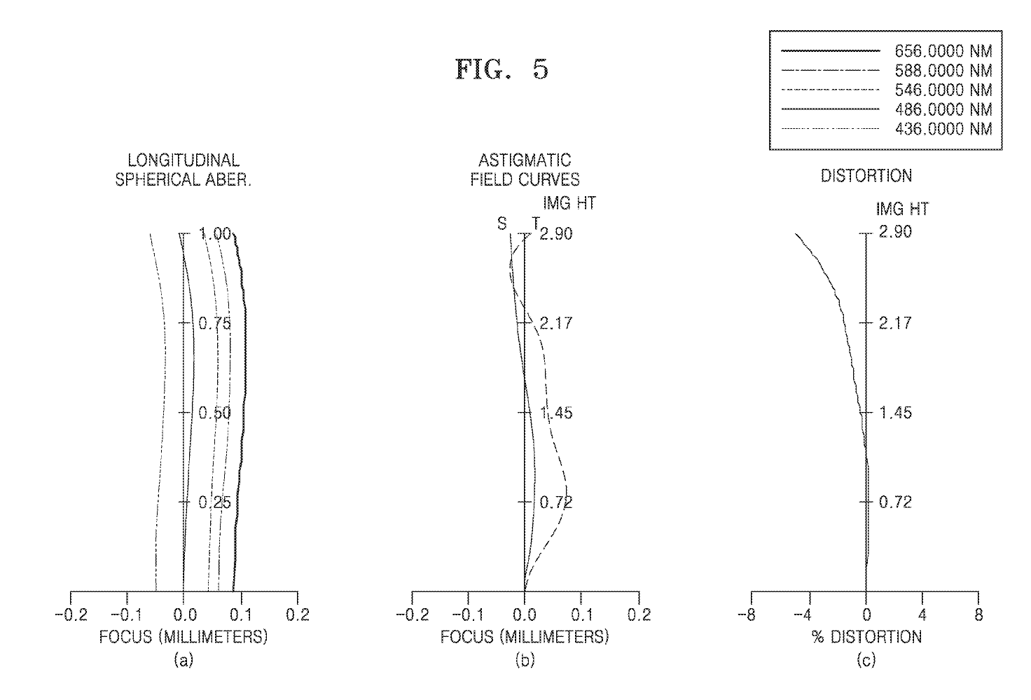

FIG. 5 illustrates (a) longitudinal spherical aberrations, (b) astigmatic field curvatures, and (c) distortion of the lens optical system of FIG. 1, that is, the lens optical system having the values of Table 2. In FIGS. 5 to 8, IMG HT denotes an image height.

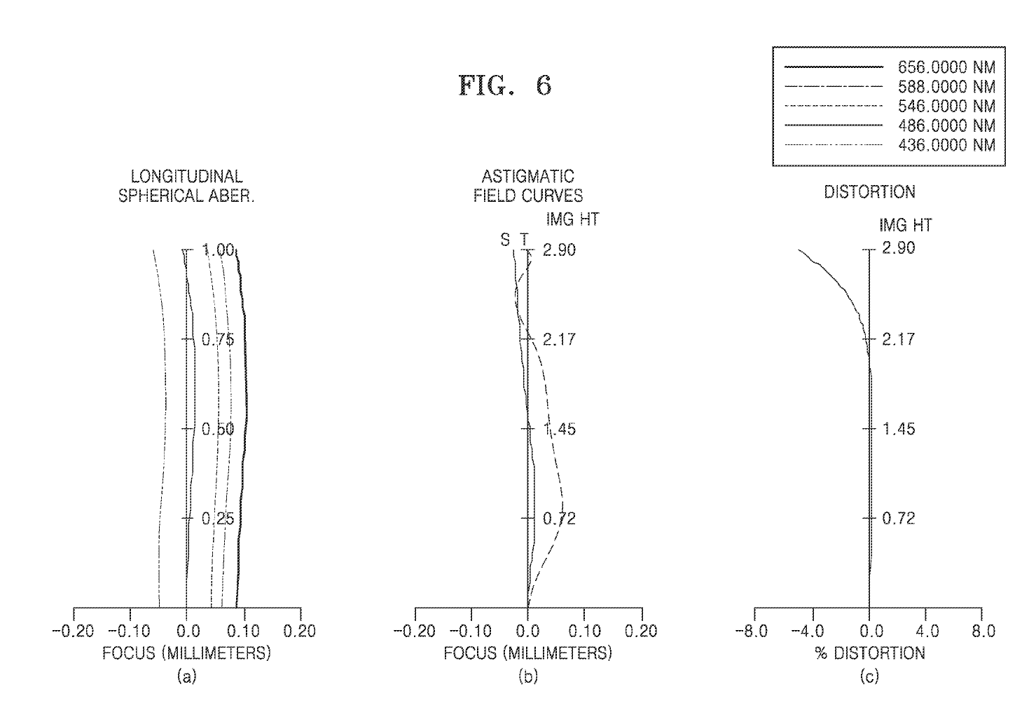

In FIG. 5, (a) shows spherical aberrations of the lens optical system with respect to light of various wavelengths, (b) shows astigmatic field curvatures of the lens optical system, that is, tangential field curvature T and sagittal field curvature S. Wavelengths of light used to obtain data of (a) were 656.0000 nm, 588.0000 nm, 546.0000 nm, 486.0000 nm, and 436.0000 nm. Wavelength of light used to obtain data of (b) and (c) was 486.0000 nm. The same wavelengths are also used to obtain data shown in FIGS. 6, 7, and 8.

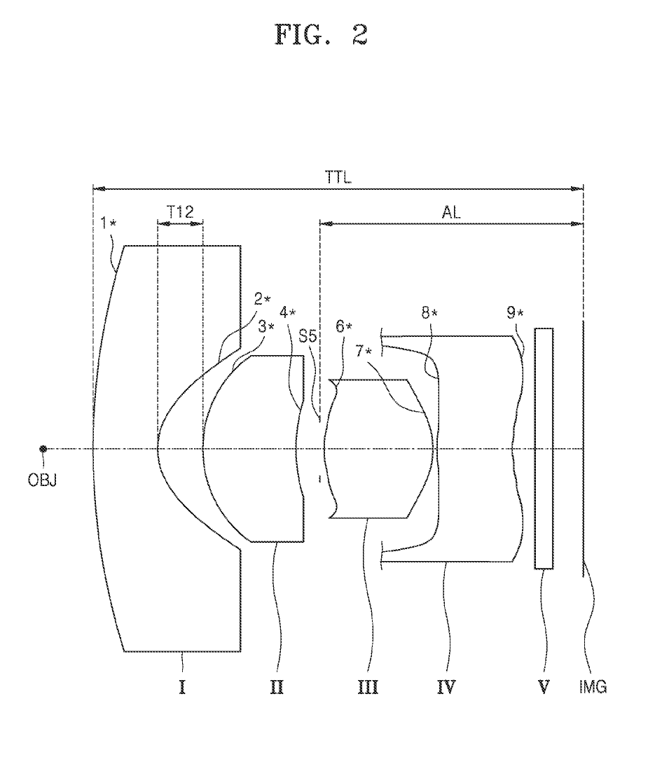

In FIG. 6, (a), (b), and (c) respectively show longitudinal spherical aberrations, astigmatic field curvatures, and distortion of the lens optical system according to the exemplary embodiment illustrated in FIG. 2, that is, the lens optical system having values shown in Table 3.

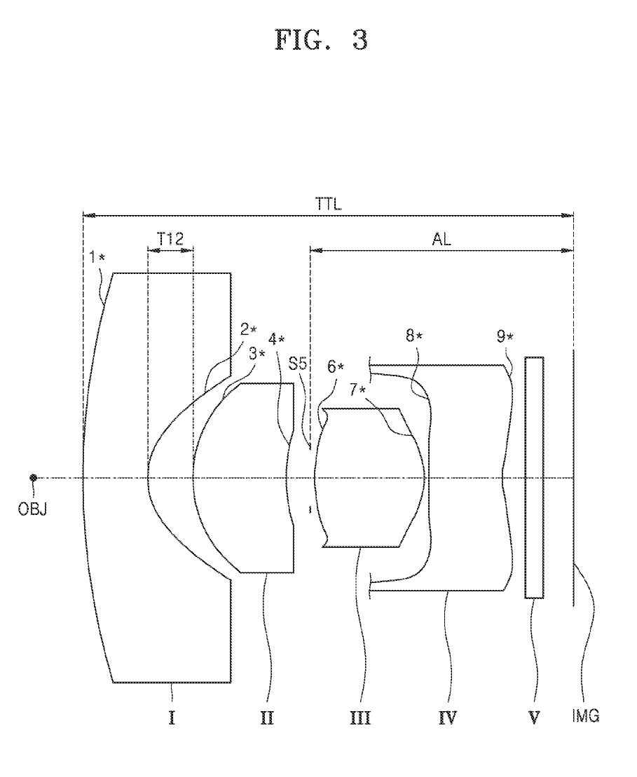

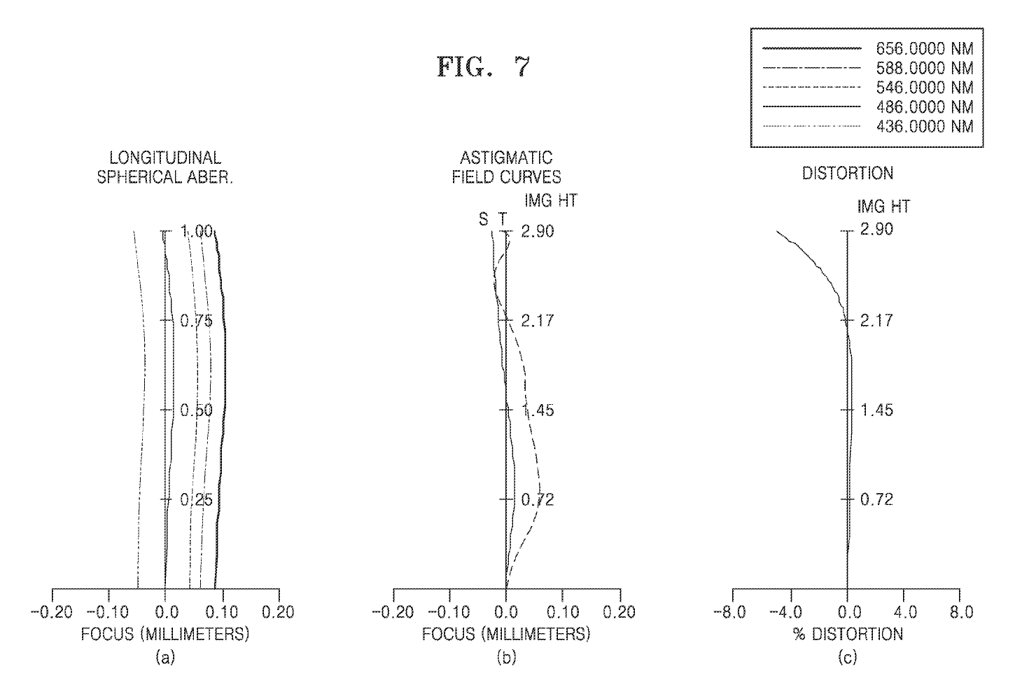

In FIG. 7, (a), (b), and (c) respectively show longitudinal spherical aberrations, astigmatic field curvatures, and distortion of the lens optical system according to the exemplary embodiment illustrated in FIG. 3, that is, the lens optical system having values shown in Table 4.

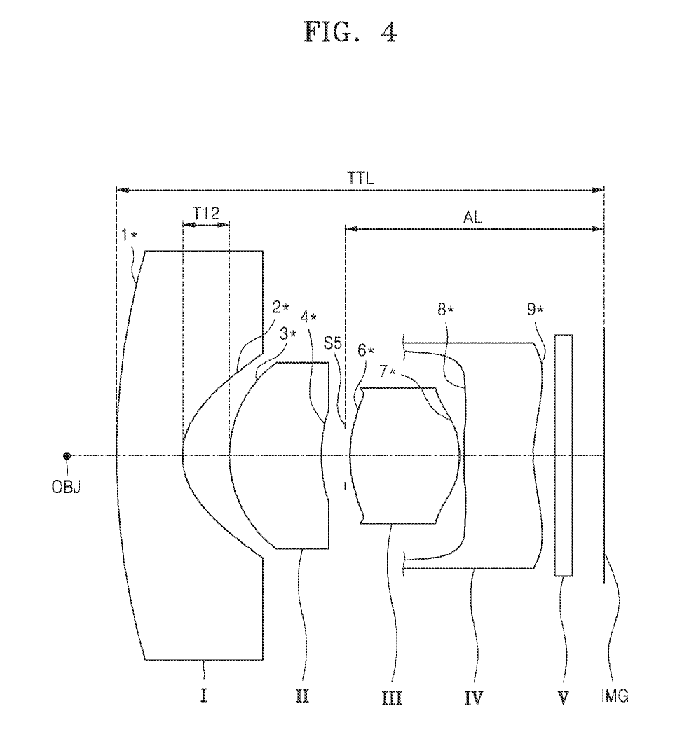

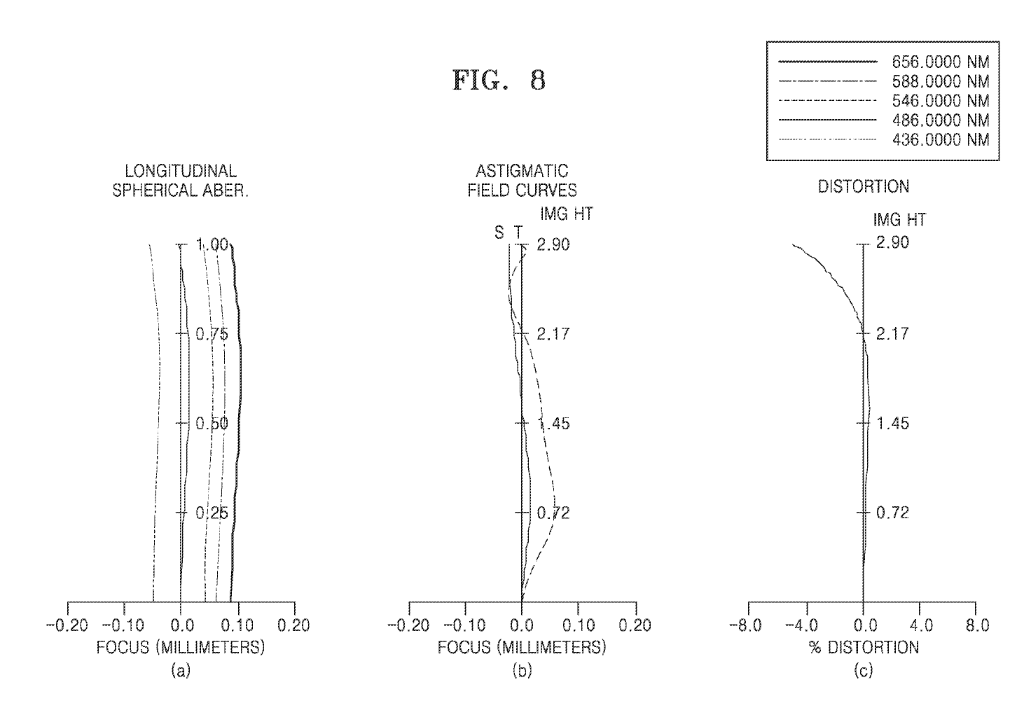

In FIG. 8, (a), (b), and (c) respectively show longitudinal spherical aberrations, astigmatic field curvatures, and distortion of the lens optical system according to the exemplary embodiment illustrated in FIG. 4, that is, the lens optical system having values shown in Table 5.

As described above, the lens optical system according to the exemplary embodiments include the first to fourth lenses I to IV respectively having the negative (−), positive (+), positive (+), and negative (−) refractive powers and arranged sequentially from the object OBJ to the image sensor IMG, and may satisfy at least one of Conditions 1 to 7.

Such lens optical systems may have a wide viewing angle and a short total length, and may easily correct various aberrations. Accordingly, the macro or super-macro optical system that is small in size, have a wide viewing angle, and have high performance and high resolution, and in particular, capable of performing a close-up or contact photography with a wide viewing angle, may be obtained.

In particular, if the incident surface 7* of the fourth lens IV is an aspherical surface having at least one inflection point from a center portion thereof to the edge, in particular, two or more inflection points from the center portion to the edge, various aberrations may be easily corrected by using the fourth lens IV, and an exit angle of a chief ray may be reduced to prevent vignetting.

Also, since the first to fourth lenses I to IV are formed of plastic and opposite surfaces (incident surface and exit surface) of each of the lenses I to IV is formed to be aspheric, the lens optical system having high performance with a compact size may be formed with less expenses than that of using the glass lens.

According to the one or more exemplary embodiments, a lens optical system may be small in size and have lightweight, and obtain high performance and high resolution. In particular, the lens optical system according to the exemplary embodiments includes the first to fourth lenses respectively having negative, positive, positive, and negative refractive powers and arranged sequentially from the object to the image sensor, and satisfies at least one of the Conditions 1 to 7. The first lens having the negative refractive power has a strong power, and the positive refractive power is distributed to the second and third lenses.

Such above lens optical system has a wide viewing angle and a short total length, and corrects various aberrations easily, and thus, is suitable for the high performance and small camera. In particular, if the incident surface of the fourth lens is an aspherical surface having two or more inflection points from the center portion to the edge, the various aberrations may be easily corrected by using the fourth lens. Also, according to the exemplary embodiments, since the macro or super-macro lens optical system having the wide viewing angle is obtained, the lens optical system may be used as a lens for sensing fingerprints.

In addition, since at least one of the first to fourth lenses is formed of plastic and opposite surfaces of each lens (incident surface and exit surface) are formed to be aspherical surfaces, the lens optical system having high performance with a compact size may be formed with less expenses than that of using the glass lens.

It should be understood that exemplary embodiments described herein should be considered in a descriptive sense only and not for purposes of limitation. For example, it would be obvious to one of ordinary skill in the art that a blocking film may be used as a filter instead of the infrared blocking unit VI. While one or more exemplary embodiments have been described with reference to the figures, it will be understood by those of ordinary skill in the art that various changes in form and details may be made therein without departing from the spirit and scope of the inventive concept as defined by the following claims.

What is claimed is:

1. A lens optical system comprising:
first to fourth lenses sequentially arranged along a light proceeding path between an object and an image sensor on which an image of the object is formed,
wherein the first lens has a negative refractive power and an incident surface convex toward the object,
the second lens has a positive refractive power and an exit surface concave from the image sensor,
the third lens has a positive refractive power and an exit surface convex toward the image sensor,
the fourth lens has a negative refractive power and an incident surface that is an aspherical surface having two or more inflection points, and
the lens optical system satisfies the following condition
90<FOV<120,
where FOV denotes a diagonal viewing angle of the lens optical system.

2. The lens optical system of claim 1, satisfying the following condition
5<|DIST|<10,
where DIST denotes an optical distortion in a sensor effective region 1.0 field.

3. The lens optical system of claim 1, further comprising an aperture located between the first lens and the second lens,
wherein the lens optical system satisfies the following condition
0.4<AL/TTL<0.9,
where AL denotes a distance from the aperture to the image sensor, and TTL denotes an optical distance from a center of an incident surface of the first lens to the image sensor.

4. The lens optical system of claim 3, satisfying the following condition
20<Vd1−Vd2<40,
where Vd1 denotes an Abbe's number of the first lens and Vd2 denotes an Abbe's number of the second lens.

5. The lens optical system of claim 4, satisfying the following condition
0.2<T12/F<0.8,
where T12 denotes an optical distance between a center of an exit surface of the first lens and a center of an incident surface of the second lens.

6. The lens optical system of claim 5, satisfying the following condition
−10.0<F4/F<−1.0,
where F denotes a total effective focal distance of the lens optical system and F4 denotes a focal distance of the fourth lens.

7. The lens optical system of claim 6, satisfying the following condition
1.0<F2/F<3.0,
where F denotes a total effective focal distance of the lens optical system and F2 denotes a focal distance of the second lens.

8. The lens optical system of claim 1, wherein the incident surface of the fourth lens has two or more inflection points from a center portion to an edge.

9. The lens optical system of claim 1, wherein one of an incident surface and an exit surface of at least one of the first to fourth lenses is an aspherical surface.

10. The lens optical system of claim 9, wherein an incident surface and an exit surface of each of the first to fourth lenses are all aspherical surfaces.

11. The lens optical system of claim 1, further comprising an aperture between the second lens and the third lens.

12. The lens optical system of claim 1, further comprising an infrared ray blocking unit between the fourth lens and the image sensor.

13. The lens optical system of claim 1, wherein at least one of the first to fourth lenses comprises a plastic lens.

14. A lens optical system comprising a first lens, a second lens, a third lens, and a fourth lens sequentially arranged between an object and an image sensor on which an image of the object is formed from the object side,
wherein the first to fourth lenses respectively have negative, positive, positive, and negative refractive powers, and the lens optical system satisfies at least one of the following Conditions 1 to 7,
90<FOV<120, <Condition 1>
where FOV denotes a diagonal viewing angle of the lens optical system,
5<|DIST|<10, <Condition 2>
where DIST denotes an optical distortion in a sensor effective region 1.0 field,
0.4<AL/TTL<0.9, <Condition 3>
where AL denotes a distance from an aperture to the image sensor, and TTL denotes an optical distance from a center of an incident surface of the first lens to the image sensor,
20<Vd1−Vd2<40, <Condition 4>
where Vd1 denotes an Abbe's number of the first lens and Vd2 denotes an Abbe's number of the second lens,
0.2<T12/F<0.8, <Condition 5>
where T12 denotes an optical distance between a center of an exit surface of the first lens and a center of an incident surface of the second lens,
−10.0<F4/F<−1.0, <Condition 6>
where F denotes a total effective focal distance of the lens optical system and F4 denotes a focal distance of the fourth lens,
1.0<F2/F<3.0, <Condition 7>
where F denotes a total effective focal distance of the lens optical system and F2 denotes a focal distance of the second lens.

15. The lens optical system of claim 14, wherein the first to fourth lenses comprise aspheric lenses.

16. The lens optical system of claim 14, wherein the first lens is a meniscus lens that is convex toward the object, the second lens is a meniscus lens that is convex toward the object, the third lens is a bi-convex lens, and the fourth lens has an incident surface having at least two inflection points.

17. The lens optical system of claim 14, further comprising an aperture between the second lens and the third lens.
